(19) United States
(12) Patent Application Publication
(10) Pub. No.: US 2025/0118782 A1
(43) Pub. Date: Apr. 10, 2025

(54) COOLING SYSTEM FOR AN APPARATUS WITH A FUEL CELL DEVICE AND AN ELECTRICAL ENERGY STORE AND METHOD FOR COOLING A FUEL CELL DEVICE

(71) Applicant: FORD GLOBAL TECHNOLOGIES, LLC, Dearborn, MI (US)

(72) Inventors: Hans Guenter QUIX, Herzogenrath (DE); Jan MEHRING, Koeln (DE)

(73) Assignee: FORD GLOBAL TECHNOLOGIES, LLC, Dearborn, MI (US)

(21) Appl. No.: 18/904,713

(22) Filed: Oct. 2, 2024

(30) Foreign Application Priority Data
Oct. 4, 2023 (DE) 102023126938.0

(51) Int. Cl. H01M 8/04746; B60K 11/02; B60L 50/75; B60L 58/40; H01M 8/04007; H01M 8/04029; H01M 8/0432; H01M 8/04701; H01M 10/613; H01M 10/625; H01M 10/633; H01M 10/6568; H01M 16/00

(52) U.S. Cl. CPC H01M 8/04768; B60K 11/02; B60L 50/75; B60L 58/40; H01M 8/04029; H01M 8/04074; H01M 8/04358; H01M 8/04723; H01M 8/04776; H01M 10/613; H01M 10/625; H01M 10/633; H01M 10/6568; H01M 16/006; H01M 2220/20; H01M 2250/20

(57) ABSTRACT

A vehicle cooling system for a fuel cell and an electrical energy store includes a first cooling circuit configured to cool the fuel cell and a second cooling circuit configured to cool the electrical energy store with the first cooling circuit and the second cooling circuit selectively fluidly connected to one another in response to temperatures of the fuel cell and electrical energy store. The first cooling circuit may include a coolant removal point arranged downstream of the fuel cell and upstream of a heat exchanger. The first cooling circuit may also include a coolant recirculation point downstream of a heat exchanger and upstream of the fuel cell.

### CROSS-REFERENCE TO RELATED APPLICATIONS

This application claims foreign priority benefits under 35 U.S.C. § 119(a)-(d) to DE Application 10 2023 126 938.0 filed Oct. 4, 2023, which is hereby incorporated by reference in its entirety.

### TECHNICAL FIELD

This disclosure relates to a cooling system for an apparatus with a fuel cell device and an electrical energy store, to a motor vehicle, and to a method for cooling a fuel cell device.

### BACKGROUND

Optimizing the cooling system power of a fuel cell device of vehicles having fuel cell drive represents a major challenge in the development of these vehicles. Compared to vehicles having internal combustion engines, the necessary heat dissipation capacity of the cooling system is higher. Moreover, the necessary temperature level of the coolant for cooling the fuel cell or the fuel cell stack is lower, this being accompanied by a lower efficiency of the heat exchangers which are usually arranged in the front region of the vehicle.

Under certain conditions, e.g. uphill journeys at high ambient temperatures, part of the required drive energy could be provided by a high-voltage battery of the vehicle to be able to reduce the power of the fuel cell and thus also the load on the cooling system. However, the battery power is limited and the state of charge of the battery is variable and so this possibility is only available in a few use cases or for a limited period of time. It should be noted that the term “battery” in the present case is used in a simplistic manner to refer to a rechargeable battery, also known as a secondary battery.

The cooling system should therefore be dimensioned such that a sufficient cooling power is available ideally under all conditions. This results in the cooling system having large dimensions, in particular the heat exchanger or exchangers in the front region of the vehicle. Optionally, lowering the fuel cell power for certain conditions, e.g. uphill journeys at high ambient temperatures, can also be considered to decrease the cooling demand. However, this can potentially result in lower customer satisfaction.

Numerous concepts for linking cooling circuits which at least indirectly also have an effect on the cooling of the fuel cells are known from the prior art.

Thermally coupling a fuel cell cooling circuit to a battery cooling circuit is known from DE 10 2015 015 635 A1, DE 10 2018 219 203 A1, DE 10 2009 035 471 A1 and U.S. Pat. No. 9,136,549 B2. However, separation of the two cooling circuits is not made possible in this case; rather, they are coupled to one another at all times. In addition, DE 10 2010 032 886 A1 discloses coupling a charge air cooling circuit of a fuel cell to a battery cooling circuit.

### SUMMARY

As described in detail herein, embodiments according to the disclosure further optimize the cooling of a fuel cell device designed in particular for driving a motor vehicle.

A first aspect of the disclosure relates to a cooling system for an apparatus with a fuel cell device and an electrical energy store. In this case, the fuel cell device can have one or more fuel cells, for example in the form of a fuel cell stack. The electrical energy store can be a battery, such as a high-voltage battery, such as can be used for example as a drive battery of a motor vehicle.

The apparatus can be arranged in a motor vehicle, wherein a motor vehicle is to be understood to mean a vehicle drivable by at least one motor, e.g. a land-based vehicle, aircraft or watercraft. The motor vehicle can be a passenger car or truck. In other words, the proposed cooling system can be designed for cooling a fuel cell device and a drive battery of a motor vehicle.

The cooling system has a first cooling circuit, which is designed for cooling the fuel cell device, and a second cooling circuit, which is designed for cooling the electrical energy store. In this case, the first cooling circuit and the second cooling circuit may be directly fluidically connected to one another. In this context, directly fluidically connected means that the two cooling circuits are able to be coupled to one another in such a way that the same coolant can flow at least in sections of both cooling circuits. Able to be connected or able to be coupled is to be understood to mean that either the two cooling circuits can be separated or the two cooling circuits can be coupled or connected, as explained in more detail below.

The direct fluidic connection can be realized for example by means of coolant lines which can transport coolant out of the first cooling circuit from a removal point into the second cooling circuit and out of the second cooling circuit to a recirculation point in the first cooling circuit.

The coolant used in both cooling circuits can for example be a water/glycol mixture, optionally provided with additives, which meet the requirements of both cooling circuits. When the cooling circuit or circuits is/are activated, the coolant flows through the respective cooling circuit and as the case may be through the connected cooling circuits.

The first cooling circuit is, as mentioned, designed for cooling the fuel cell device. For example, the first cooling circuit can be used to ensure that a maximum temperature for the fuel cell device, measured directly upstream of the fuel cell device or at the input thereof, in the range between 55° C. and 60° C. is complied with.

The first cooling circuit can have a heat exchanger, for example for exchanging heat between the coolant and the ambient air. Advantageously, such a heat exchanger can be arranged in the front region of a motor vehicle equipped with the cooling system, to allow as good a heat dissipation as possible. To form and reinforce a flow of coolant through the first cooling circuit, the latter can have a coolant pump, e.g. a water pump.

Optionally, a bypass line for bypassing the heat exchanger, and a temperature control valve arranged at a branch-off point of the bypass line, i.e. at the removal or recirculation point of the bypass line, can be arranged. The temperature control valve can be used to influence the temperature of the coolant in a certain region in which more or less coolant is led through the bypass line instead of to the heat exchanger and as a result is cooled to a lesser degree. For this purpose, the temperature control valve can cooperate with a temperature sensor which can be arranged for example directly upstream of the fuel cell device or at the input thereof and measures the temperature of the coolant and allow the coolant temperature to be controlled.

Furthermore, an equalizing vessel can optionally be incorporated into the first cooling circuit.

The second cooling circuit is, as mentioned, designed for cooling the electrical energy store device. For example, the second cooling circuit can be used to ensure that a maximum temperature for the electrical energy store in the range between 25° C. and 40° C. is complied with. For achieving this temperature of the electrical energy store, the temperature of the coolant of the second cooling circuit can for example be below 25°-30° C., measured directly upstream of the electrical energy store or at the input thereof. Depending on the cooling concept of the electrical energy store, the coolant temperature upstream of the electrical energy store can also be considerably below the specified values.

The second cooling circuit can have a cooler to cool the coolant flowing through the second cooling circuit. The cooler can be used to ensure heat exchange between the coolant and a refrigerant. In other words, the second cooling circuit can have a cooler that is thermally coupled to a refrigerant circuit.

As is usual, the refrigerant circuit can have an electrically operated refrigerant compressor and a condenser. An evaporator, e.g. for cooling a vehicle interior, can optionally be incorporated into the refrigerant circuit.

To form and reinforce a flow of coolant through the second cooling circuit, the latter can have a coolant pump, e.g. a water pump. Optionally, an equalizing vessel can be incorporated into the second cooling circuit.

The first and the second cooling circuit can be operated essentially at ambient pressure, i.e. both cooling circuits are not refrigerant circuits.

The possibility of the direct fluidic connection of the first and second cooling circuit allows, on the one hand, the fuel cell device and the electrical energy store to be cooled separately from one another in the non-connected state. As a result, required cooling in particular of the electrical energy store can be ensured.

On the other hand, in the connected state, additional cooling of the fuel cell device is made possible by means of the cooling capacity of the second cooling circuit, e.g. by using the cooler arranged therein. This can also allow the fuel cell device to operate at higher power, which otherwise, due to inadequate cooling of the fuel cell device, would either not be possible or only possible by cooling with a cooling device with correspondingly large dimensions and associated large space requirement.

According to various embodiment variants, provision can be made for the first cooling circuit and the second cooling circuit to be able to be operated separately from one another in a first operating mode.

This first operating mode advantageously allows the fuel cell device and the electrical energy store to be cooled independently of one another. The different cooling requirements of the fuel cell device and of the electrical energy store can thus be satisfied in a simple manner.

The cooling system may be operated in the first operating mode if both the fuel cell device and the electrical energy store need to be cooled. In this regard, reference is made to the explanations below.

According to further embodiment variants, the first cooling circuit and the second cooling circuit may be able to be operated coupled to one another, without incorporation of the electrical energy store, in a second operating mode.

In other words, it is possible to form a cooling circuit which comprises the first cooling circuit, parts of the second cooling circuit, i.e. without the portion in which the electrical energy store device is incorporated, and connection lines between the first and the second cooling circuit. For this purpose, provision can be made for corresponding branching points in the first and second cooling circuit, which are suitably provided with one or more flow control valves.

If the cooler of the second cooling circuit is coupled to a refrigerant circuit, this cooler can thus preferably be activated or become activated in the second operating mode.

The second operating mode advantageously allows the cooling capacity of the second cooling circuit to be used for cooling the fuel cell device. Through suitable addition of the coolant in the second cooling circuit, which coolant is greatly cooled in relation to the coolant in the first cooling circuit, the temperature of the coolant directly upstream of the fuel cell device can be adjusted as needed, i.e. depending on the necessary cooling requirement which for its part depends, among other things, on the current power of the fuel cell device. For example, the temperature of the coolant can be reduced by a further 5 to 10 K.

According to further embodiment variants, the cooling system can have a control unit, configured and designed for generating control signals which cause the cooling system to operate in the first or second operating mode.

The control unit may be realized in hardware and/or software form and may physically be of single-part or multi-part form. In particular, the control unit can be part of, or integrated into, a drive controller. The control unit is in operative signal connection with one or more actuators of the cooling circuits, e.g. flow control valves, to be able to transmit the generated control signals to said actuators and thus control the operation of the cooling system.

The control unit allows selective operation of the cooling system in the first or second operating mode. Optionally, further operating modes can be provided.

The control unit can be configured and designed for generating the control signals on the basis of a temperature of the electrical energy store and a temperature of the fuel cell device. In other words, the control unit can allow targeted selection of the first or second operating mode based on the temperatures of the electrical energy store and the fuel cell device.

For this purpose, the control unit can receive sensor signals from temperature sensors measuring the temperature of the fuel cell device and/or the electrical energy store device, process these sensor signals based on instructions or a code which is programmed in the control unit and corresponds to one or more routines, and transmit the control signals to one or more actuators of the cooling system. The temperature sensors for measuring the temperatures of the fuel cell device and electrical energy store device can for example be part of the proposed cooling system. The temperature of the electrical energy store device, e.g. the battery cell temperature, can also be measured directly using a temperature sensor correspondingly arranged on or in the electrical energy store device.

Optionally, the control unit can be for generating the control signals taking into account at least one influencing factor. In this case, the influencing factor(s) can be selected from a group comprising: a state of charge of the electrical energy store, a speed of a motor vehicle equipped with the cooling system, an ambient temperature, a required drive power of the motor vehicle equipped with the cooling system and an opening position of a coolant valve.

In other words, one or more of the influencing factors can be used in addition to the temperatures of the fuel cell device and the electrical energy store device in order to make a decision about the operation of the cooling system in the first or second operating mode, to generate corresponding control signals and to output them to the actuators of the cooling system.

According to further embodiment variants, provision can be made for a removal point for a cooling medium from the first cooling circuit to be arranged downstream of a heat exchanger arranged in the first cooling circuit and upstream of the fuel cell device that is to be cooled.

This means that, when the first and second cooling circuits are connected, that is to say in the second operating mode, coolant that is pre-cooled by the heat exchanger in the first cooling circuit is led into the second cooling circuit and cooled further there, e.g. by means of the cooler arranged in the second cooling circuit and operated with a refrigerant circuit.

Alternatively or in addition, a removal point for a cooling medium from the first cooling circuit can be arranged downstream of the fuel cell device that is to be cooled and upstream of a heat exchanger arranged in the first cooling circuit. The removal point can be arranged downstream of a temperature control valve arranged at a branch-off point of a bypass line for bypassing the heat exchanger of the first cooling circuit.

This means that, when the first and second cooling circuits are connected, that is to say in the second operating mode, the coolant that is heated by contact with the fuel cell device is first led into the second cooling circuit and is cooled there, e.g. by means of the cooler arranged in the second cooling circuit and operated with a refrigerant circuit. Here, the coolant supplied to the cooler thus has a higher temperature than in the variant described previously.

The position of the removal point can be, among other things, dependent on the operating parameters of the cooler, e.g. the input temperature region thereof. The two described possibilities for the position of the removal point allow the cooling capacity of the fuel cell device to be optimized, in particular adapted to suit the specific operating parameters of the cooler.

According to further embodiment variants, a recirculation point for the cooling medium into the first cooling circuit can be arranged downstream of the heat exchanger arranged in the first cooling circuit and upstream of the fuel cell device that is to be cooled.

This allows the fuel cell device to be cooled efficiently since the supply of the coolant cooled in the second cooling circuit is recirculated into the first cooling circuit ideally directly upstream of the fuel cell device.

A further aspect of the disclosure relates to a motor vehicle with a fuel cell device, an electrical energy store and a cooling system as described above.

Therefore, the above statements for explaining the proposed cooling system also serve for describing the motor vehicle. The advantages of the cooling system correspondingly relate to the motor vehicle.

A further aspect of the disclosure relates to a method for cooling a fuel cell device by means of a cooling system as described above, wherein the cooling system is operated in the first operating mode if the electrical energy store needs to be cooled, and wherein the cooling system is operated in the second operating mode if the electrical energy store does not need to be cooled.

The proposed method is performed by means of the cooling system explained above. In this respect, the above statements for explaining the cooling system also serve for describing the proposed method. The advantages of the cooling system correspondingly relate to the method. The method can for example be performed in a motor vehicle which is equipped with a corresponding cooling system, a fuel cell device and an electrical energy store.

In order to further explain the conditions under which the electrical energy store needs or does not need to be cooled, reference is made to the following statements. The electrical energy store may not need to be cooled if the temperature thereof is already low enough without cooling and/or if the state of charge of the electrical energy store is too low for further use and the electrical energy store is therefore deactivated.

According to various embodiment variants, it is possible for a power of the fuel cell device to be able to be varied on the basis of the operation of the cooling system in the first or second operating mode.

For example, operation of the cooling system in the second operating mode can involve a higher power of the fuel cell device than operation of the cooling system in the first operating mode. In other words, the power of the fuel cell device in the second operating mode can be higher than in the first operating mode.

The possibility of increasing the power of the fuel cell device in the second operating mode compared to the first operating mode can allow the power requirement to be completely or almost completely met by the fuel cell device even under difficult operating conditions, e.g. high ambient temperature, uphill driving, etc.

Further advantages are evident from the figures and the associated description, on the basis of which representative embodiments of the claimed subject matter will be explained in more detail below.

### BRIEF DESCRIPTION OF THE DRAWINGS

FIG. 1 shows a schematic illustration of a cooling system with cooling circuits according to the prior art;

FIG. 2 shows a schematic illustration of a cooling system of an embodiment according to the disclosure;

FIG. 3 shows the cooling system of the FIG. 2 embodiment in a first operating mode;

FIG. 4 shows the cooling system of the FIG. 2 embodiment in a second operating mode;

FIG. 5 shows a schematic illustration of a cooling system of another embodiment according to the disclosure;

FIG. 6 shows a flowchart of a method for controlling or operating a cooling system according to the disclosure;

FIG. 7 illustrates a possible meeting of a power requirement by the fuel cell device and the electrical energy store; and

FIG. 8 is a schematic illustration of a representative motor vehicle according to one or more embodiments of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

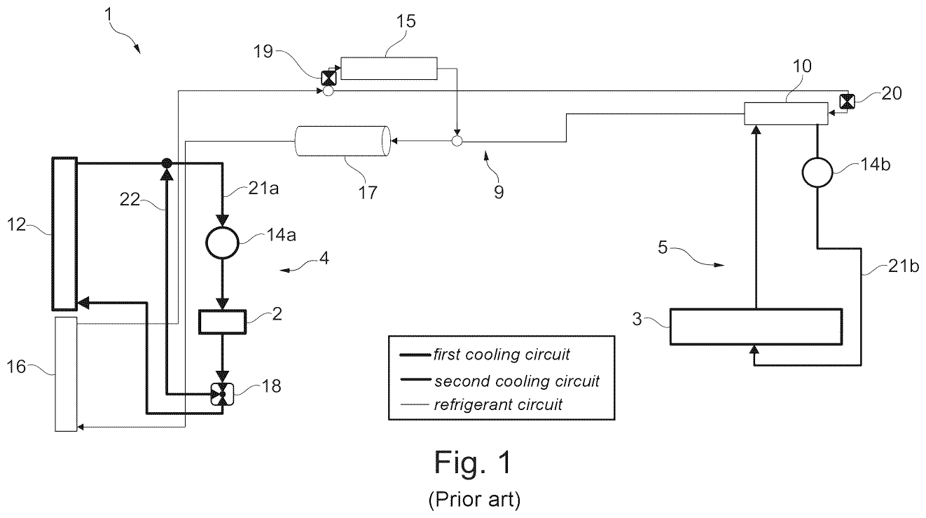

FIG. 1 shows a cooling system 1 according to the prior art which can for example be used in a motor vehicle 100 the drive energy of which is available from a fuel cell device 2 and an electrical energy store 3, i.e. a battery. Both the fuel cell device 2 and the electrical energy store 3 usually require cooling in order not to exceed a temperature upper limit of the fuel cell device FC_{Thresh} and a temperature upper limit of the electrical energy store Batt_{Thresh}, respectively.

According to the prior art, separate cooling circuits are provided for the purpose of cooling, i.e. a first cooling circuit 4 for cooling the fuel cell device 2 and a second cooling circuit 5 for cooling the electrical energy store 3. The fuel cell device 2 and the electrical energy store 3 are thus cooled completely independently of one another.

The first cooling circuit 4 is formed by coolant lines 21a which connect the individual devices of the first cooling circuit 4 to one another and through which coolant flows. To form a flow of coolant in the first cooling circuit 4, the first cooling circuit has a coolant pump 14a. Furthermore, a heat exchanger 12 which allows heat exchange between the coolant and the environment is arranged in the first cooling circuit 4. The heat exchanger 12 is thus in the form of a coolant-air heat exchanger. The heat exchanger 12 can be arranged in a front region of the motor vehicle 100 to allow as good a heat dissipation to the environment as possible with as little influence as possible from other heat exchangers present in the motor vehicle 100.

The first cooling circuit 4 can additionally have a bypass line 22 for bypassing the heat exchanger 12. A temperature control valve 18, which for example can be arranged in the first cooling circuit 4 in the position shown in FIG. 1, i.e. at a branch-off point of the bypass line 22, can be used to define whether and how much coolant flows through the bypass line 22 and is therefore not cooled by means of the heat exchanger 12. The temperature of the coolant in the first cooling circuit 4 can therefore be controlled within certain limits by adjusting a valve position of the temperature control valve 18. Optionally, an equalizing tank (not illustrated) can be provided in the first cooling circuit 4.

The second cooling circuit 5 is formed by coolant lines 21b which connect the individual devices of the second cooling circuit 5 to one another and through which coolant flows. The second cooling circuit 5 includes a coolant pump 14b. Optionally, an equalizing tank (not illustrated) can likewise be provided in the second cooling circuit 5.

Furthermore, a cooler 10 which is thermally coupled to a refrigerant circuit 9 and allows heat exchange between the coolant and a refrigerant flowing through the refrigerant circuit 9 is arranged in the second cooling circuit 5. The cooler 10 is thus in the form of a coolant-refrigerant heat exchanger. Stronger cooling of the coolant in the second cooling circuit 5 compared to the first cooling circuit 4 is made possible by thermally coupling the second cooling circuit 5 to the refrigerant circuit 9 via the cooler 10. As a result, a lower temperature of the electrical energy store T_{Batt} compared to the temperature of the fuel cell device T_{FC} can be achieved.

The refrigerant circuit 9 thermally coupled to the second cooling circuit 5 is constructed as usual. The refrigerant circuit 9 has a refrigerant compressor 17 and a condenser 16 as well as a refrigerant valve 20, the operating principle of which is known to those skilled in the art. In addition, provision is made for an evaporator 15 which can be arranged for example in an interior of the motor vehicle 100 and can be used for the air conditioning, in particular the cooling, of the vehicle interior.

As previous described, according to the prior art the two cooling circuits 4, 5 are designed to be separated from one another at all times. The consequence of this is that if the fuel cell device 2 is insufficiently cooled the power thereof decreases or at least cannot be increased, so as not to exceed the temperature upper limit of the fuel cell device FC_{Thresh}. This can have a negative effect when it is no longer possible for the motor vehicle 100 to be driven by means of the electrical energy store 5 because a state of charge of the electrical energy store 5 is no longer sufficient, for example. To maintain a desired drive power of the motor vehicle 100, the lost proportion of the electrical energy store 5 would have to be compensated for by the fuel cell device 2, this usually entailing an increase in the temperature of the fuel cell device T_{FC} and therefore a higher cooling requirement which however cannot be covered by the first cooling circuit 4 alone.

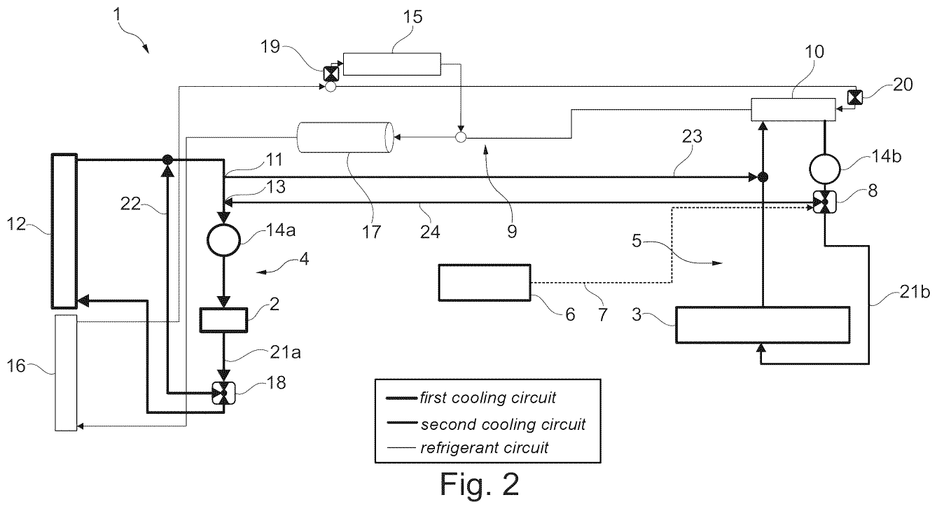

In order to be able to increase the cooling of the fuel cell device 2 in the aforementioned situation, among others, a modification to the cooling system 1 is provided according to the present disclosure. FIG. 2 shows a first representative embodiment of such a modified cooling system 1′ in a schematic illustration. Only the differences compared to the cooling system 1 of FIG. 1 are explained below; otherwise reference is made to the explanations with regard to FIG. 1.

The cooling system 1′ of FIG. 2 is distinguished in that the first cooling circuit 4 and the second cooling circuit 5 are able to be directly fluidically connected to one another. For this purpose, provision is made for a supply line 23 and a recirculation line 24 which, as needed, lead the coolant from a removal point 11 arranged in the first cooling circuit 4 to the second cooling circuit 5 and from the second cooling circuit 5 to a recirculation point 13 arranged in the first cooling circuit 4. The coolant used is water, optionally provided with additives.

In the first embodiment, the removal point 11 is arranged downstream of the heat exchanger and upstream of the fuel cell device 2. In other words, the heat exchanger 12 and the cooler 10 are arranged parallel to one another in relation to the flow of the coolant when the cooling system 1′ is operating in the second operating mode B (see following explanation of the operating modes).

The recirculation point 13 is arranged downstream of the heat exchanger 12 and upstream of the fuel cell device 2. In addition, in the first exemplary embodiment, the removal point 11 is arranged upstream of the recirculation point 13.

In order to couple the first cooling circuit 4 to the second cooling circuit 5 to one another as needed, i.e. only when particular conditions exist, a coolant valve 8 is provided. Coupling the two cooling circuits 4, 5 as needed is realized by means of a controller or control unit 6 and control signals 7 which are generated and output by the control unit 6, output to the coolant valve 8 and cause a change in the valve position, i.e. in the opening state of the coolant valve 8.

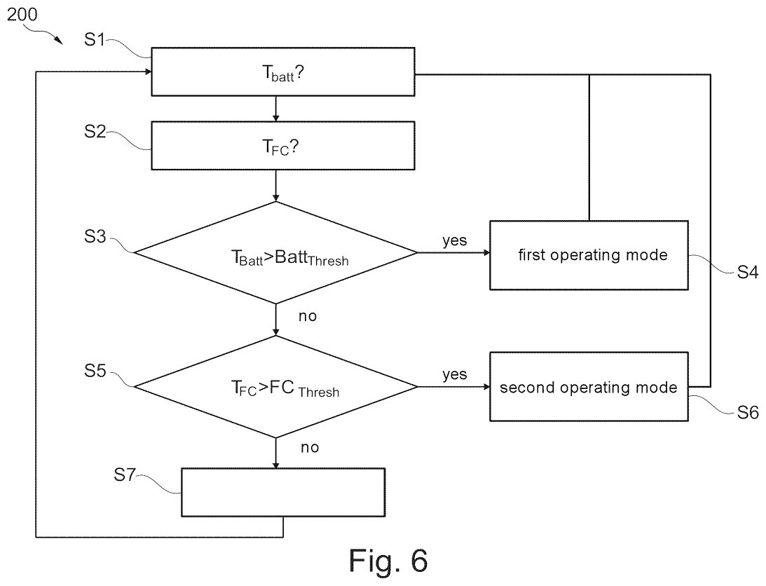

The controller or control unit 6 can generate the control signals 7 in particular on the basis of the temperature of the electrical energy store T_{Batt} and the temperature of the fuel cell device T_{FC}, as explained in more detail below with reference to FIG. 6. In order to ascertain the temperature of the electrical energy store T_{Batt} and the temperature of the fuel cell device T_{FC}, provision can be made for temperature sensors (not illustrated) the sensor signals of which are transmitted to the control unit 6 and processed by the control unit 6. A temperature sensor for ascertaining the temperature of the electrical energy store T_{Batt} can for example be arranged directly in or on the electrical energy store 3 in order to measure the battery cell temperature directly. A temperature sensor for ascertaining the temperature of the fuel cell device Tre can for example be arranged in the first cooling circuit 4 directly upstream of the fuel cell device 2 to measure the coolant temperature at the input of the fuel cell device 2.

Controller or control unit 6 may be implemented by a programmable microprocessor having stored data and instructions that, when executed, perform a method for controlling a cooling system or vehicle having a cooling system 1′. The stored data and instructions may be stored in a volatile and/or non-volatile memory or other non-transitory computer readable storage media. The instructions of the programmed microprocessor and/or hardware logic control circuitry perform one or more control functions or algorithms to control one or more outputs in response to one or more inputs. The control functions or algorithms may be represented schematically by a flowchart or similar diagram, such as illustrated in FIG. 6 and described in greater detail herein.

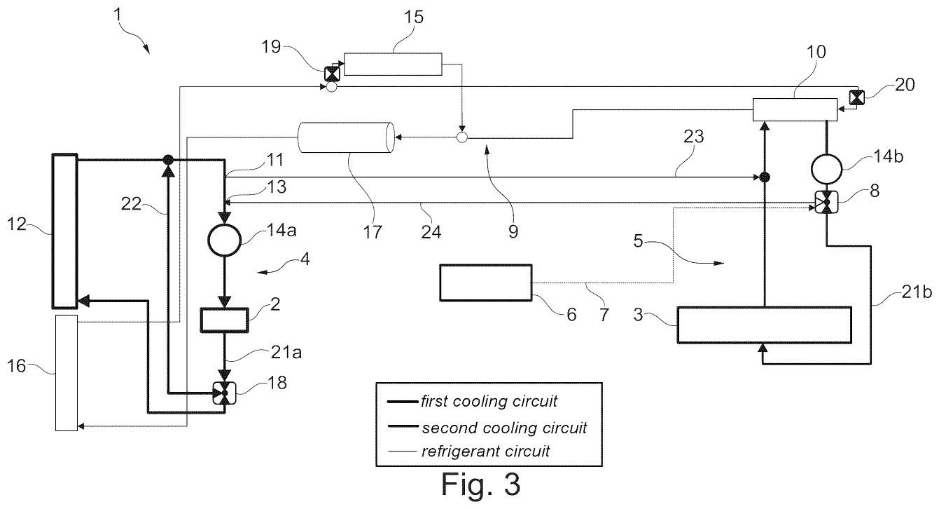

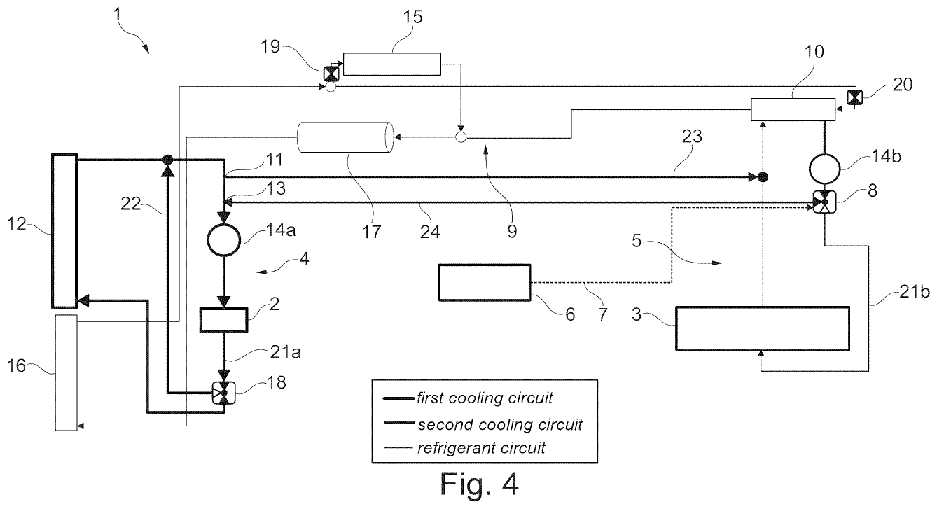

In the embodiment of FIG. 2, the coolant valve 8 is in the form of a three-way valve. As a result, on the basis of the valve position of the coolant valve 8, it is possible, on the one hand, to define whether the first and second cooling circuits 4, 5 are coupled to one another or not, and it is possible, on the other hand, to define whether the electrical energy store 3 is incorporated into the cooling circuit or not. This is explained in more detail below with reference to FIGS. 3 and 4. The function of the coolant valve 8 as a three-way valve can alternatively also be realized by two separate valves.

FIG. 3 shows the cooling system 1′ of the first embodiment according to FIG. 2 in a first operating mode A in which the first cooling circuit 4 and the second cooling circuit 5 are operated separately from one another. The fuel cell device 2 and the electrical energy store 3 are therefore cooled independently of one another according to the necessary cooling requirement in each case.

In order to activate the first operating mode A, the control unit 6 generates a control signal 7 which is output to the coolant valve 8 and causes the flow through the recirculation line 24 to be interrupted and the electrical energy store 3 to be incorporated into the second cooling circuit 5.

FIG. 4 shows the cooling system 1′ of the first embodiment according to FIG. 2 in a second operating mode B in which the first cooling circuit 4 and the second cooling circuit 5 are operated coupled to one another, wherein the electrical energy store 3 is not incorporated into the second cooling circuit 5, however. This means, on the one hand, that there is no cooling of the electrical energy store 3 by means of the cooling system 1 in the second operating mode B. On the other hand, the fuel cell device 2 is cooled to a greater degree, by virtue of the coolant being cooled not only by means of the heat exchanger 12 but additionally by means of the cooler 10.

In order to activate the second operating mode B, the control unit 6 generates a control signal 7 which is output to the coolant valve 8 and causes the flow through the recirculation line 24 to be enabled and the flow in the direction of the electrical energy store 3 to be interrupted. By influencing the flow rate in the recirculation line 24, a mixed temperature of the coolant can be defined in order to be able to meet the cooling requirement of the fuel cell device 2 without the refrigerant circuit 9 having to be unnecessarily loaded or activated. The flow rate in the recirculation line 24 can likewise be influenced by means of a control signal 7 which is generated by the control unit 6 and output to the coolant valve 8, by virtue of said control signal causing a corresponding change in the valve opening.

In the second operating mode B, the bypass line 22 can preferably additionally be or become deactivated such that all of the coolant flows through the heat exchanger 12 and is cooled as much as possible.

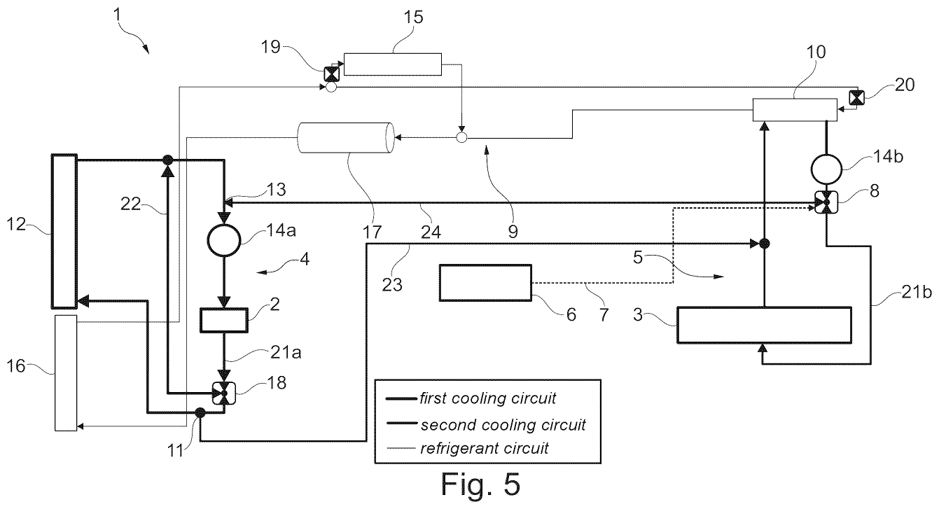

In FIG. 5, a second embodiment of a cooling system 1 is schematically illustrated. Only the changes with respect to the cooling system of the first embodiment (FIG. 2) will be explained in more detail below; otherwise reference is made to the explanation of the first embodiment. In particular, the two operating modes A, B can likewise be realized in an analogous manner using the cooling system 1″ of the second exemplary embodiment.

The cooling system 1″ of the second embodiment differs from the cooling system 1′ of the first embodiment by way of the positioning of the removal point 11. Whereas the removal point 11 in the first embodiment is arranged downstream of the heat exchanger 12 and upstream of the fuel cell device 2, the removal point 11 in the second embodiment, as shown in FIG. 5, is arranged downstream of the fuel cell device 2 and upstream of the heat exchanger 12. In other words, the heat exchanger 12 and the cooler 10 are arranged parallel to one another in relation to the flow of the coolant when the cooling system 1″ is operating in the second operating mode B.

The consequence of this is that the coolant led into the second cooling circuit 5 by means of the supply line 23 in the second operating mode B has a higher temperature compared to the first embodiment since it previously cooled the fuel cell device 2 and absorbed heat in the process. Depending on the configuration of the refrigerant circuit 9, this can have a positive effect on the subsequent cooling of the coolant by means of the cooler 10.

FIG. 6 shows a flowchart of a method 200 for cooling a fuel cell device 2. The method 200 can be carried out for example by means of the cooling system 1′ of the first embodiment (FIG. 2) or the cooling system 1″ of the second embodiment (FIG. 5) described above.

In method step S1, the temperature of the electrical energy store T_{Batt} is ascertained, e.g. by means of one or more temperature sensors in or on the electrical energy store 3 or in or on the battery cells. In method step S2, the temperature of the fuel cell device T_{FC} is ascertained, e.g. by means of a further temperature sensor which can be arranged, e.g., directly upstream of the fuel cell device 2, and the temperature of the coolant at this point is ascertained, from which the temperature of the fuel cell device T_{FC} can be derived.

In method step S3, it is checked whether the electrical energy store 3 needs to be cooled. For this purpose, it can be ascertained, for example, whether the temperature of the electrical energy store T_{Batt} exceeds the temperature upper limit of the electrical energy store Batt_{Thresh}, i.e. whether T_{Batt}>Batt_{Thresh} holds true. The temperature upper limit of the electrical energy store Batt_{Thresh} can for example be in the range between 30° C. and 45° C., in particular in the range between 35° C. and 40° C., e.g. is 38° C. When the temperature upper limit of the electrical energy store Batt_{Thresh} is exceeded, proper functioning of the electrical energy store 2 is no longer ensured and so cooling should take place to a temperature below the temperature upper limit Batt_{Thresh}. If it is determined in method step S3 that the electrical energy store 3 needs to be cooled, that is to say T_{Batt}>Batt_{Thresh} holds true, the method 200 is thus continued with method step S4.

In method step S4, the cooling system 1′ or 1″ is operated in the first operating mode A. In other words, the first cooling circuit 4 and the second cooling circuit 5 are operated separated from one another. The electrical energy store 3 can thus be sufficiently cooled. The method 200 can then be continued again with method step S1, i.e. it can be continuously checked whether T_{Batt}>Batt_{Thresh} holds true and furthermore whether the electrical energy store 3 needs or does not need to be cooled.

In contrast, if it is determined in method step S3 that the electrical energy store 3 does not need to be cooled, that is to say T_{Batt}>Batt_{Thresh} does not hold true, the method 200 is thus continued with method step S5.

In method step S5, it is checked whether the fuel cell device 2 needs to be cooled. For this purpose, it can be ascertained, for example, whether the temperature of the fuel cell device T_{FC} exceeds the temperature upper limit of the fuel cell device FC_{Thresh}, i.e. whether T_{FC}>FC_{Thresh} holds true. The temperature upper limit of the fuel cell device FC_{Thresh} can for example be in the range between 50° C. and 65° C., in particular in the range between 55° C. and 60° C., e.g. is 55° C. When the temperature upper limit of the fuel cell device FC_{Thresh} is exceeded, proper functioning of the fuel cell device 2 is no longer ensured and so cooling should take place to a temperature below the temperature upper limit FC_{Thresh}. Alternatively or in addition, the power of the fuel cell device 2 could be reduced to facilitate cooling. If it is determined in method step S5 that the fuel cell device 2 needs to be cooled, that is to say T_{FC}>FC_{Thresh} holds true, the method 200 is thus continued with method step S6.

In method step S6, the cooling system 1′ or 1″ is operated in the second operating mode B. In other words, the first cooling circuit 4 and the second cooling circuit 5 are coupled to one another, wherein the electrical energy store 3 is not incorporated and is therefore no longer cooled. In the representative embodiment, the cooler 10 of the second cooling circuit 5 is activated, i.e. the refrigerant circuit 9 is in an activated state or becomes activated. The fuel cell device 2 is cooled to a greater degree in the second operating mode B since the coolant is cooled not only by the heat exchanger 12 but additionally by the cooler 10. The method 200 can then be continued again with method step S1, i.e. it can be continuously checked whether T_{Batt}>Batt_{Thresh} holds true and whether the electrical energy store 3 needs or does not need to be cooled.

In contrast, if it is determined in method step S5 that the electrical energy store 3 does not need to be cooled, that is to say T_{Batt}>Batt Thresh does not hold true, the method 200 is thus continued with method step S7.

In method step S7, the cooler 10 is deactivated, for example, by virtue of the refrigerant circuit becoming deactivated. The method can then be continued with method step S1.

Method steps S1 and S2 can also be carried out in reverse order or temporally parallel at least in part, in particular also continuously. Moreover, method step S2 can also be performed at a later point in time at which the temperature of the fuel cell device T_{FC} is required for carrying out the method 200 further, that is to say, e.g., when method step S3 reveals that T_{Batt}>Batt_{Thresh} holds true.

In addition to the temperatures of the electrical energy store T_{Batt} and the fuel cell device T_{FC}, further influencing factors can be considered when deciding whether the cooling system 1′, 1″ is operated in the first operating mode A or in the second operating mode B. Such possible further influencing factors are the state of charge of the electrical energy store 3, the speed of a motor vehicle 100 equipped with the cooling system 1, the ambient temperature, the required drive power of the motor vehicle 100 and an opening position of the coolant valve 8. Including one or more of these influencing factors allows more stable control of the coolant temperature to be achieved.

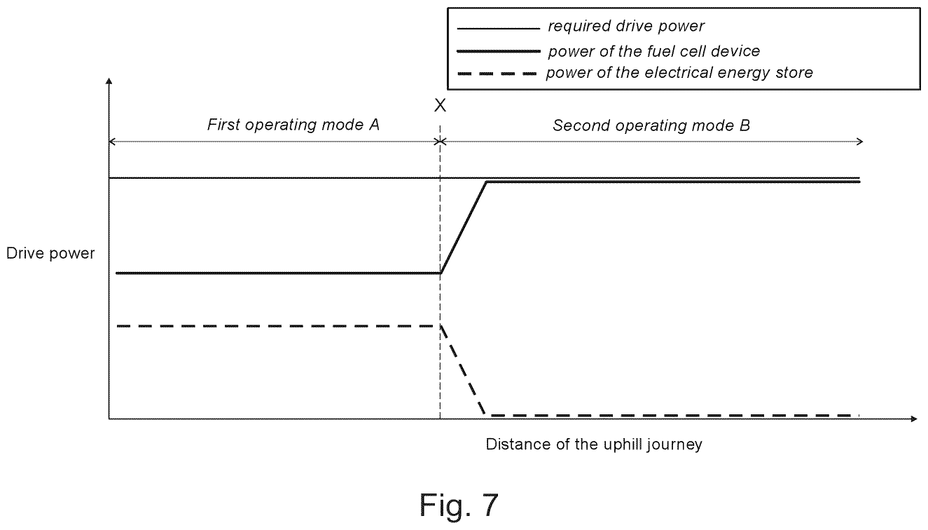

A possible inclusion of the influencing factors state of charge of the electrical energy store 3 and required drive power of the motor vehicle 100 is explained in more detail below with reference to FIG. 7.

In FIG. 7, an uphill journey of a motor vehicle 100 equipped with the cooling system 1′, 1″ is considered, wherein the motor vehicle 100 can be driven either by means of the electrical energy store 3 or the fuel cell device 2 or in combined fashion by means of the electrical energy store 3 and the fuel cell device 2. The distance or duration of the uphill journey is plotted on the x-axis; the drive power of the motor vehicle 100 is plotted on the y-axis. The simplified assumption is that a constant drive power is required for the entire uphill journey. The required drive power can be satisfied by the power of the fuel cell device 2 and/or the power of the electrical energy store 3, i.e. the power of the fuel cell device 2 and the power of the electrical energy store 3 together meet the required drive power.

At the start of the uphill journey, the cooling system is operated in the first operating mode A, i.e. with separated cooling circuits 4, 5. The available power of the fuel cell device 2 in this case is limited by the cooling of the fuel cell device 2, that is to say the performance of the first cooling circuit 4. Since the electrical energy store 3 is sufficiently cooled in the first operating mode A, it can make a partial contribution to the drive power. In other words, for the duration of the first operating mode A, the drive power of the motor vehicle 1 is satisfied both by the fuel cell device 2 and by the electrical energy store 3.

As the distance or duration increases, the state of charge of the electrical energy store 3 drops. At the point in time X or after completing a distance X, a lower limit of the state of charge, for example a residual capacity of 5%, is reached and the energy store 3 is deactivated and the associated power provide reduces to zero.

If the cooling system were to continue to operate in the first operating mode A, the power provided by the electrical energy store 3 would be missing and it would thus no longer be possible to satisfy the necessary drive power of the motor vehicle 100. As such, the cooling system is operated in the second operating mode B from point X onward.

Since a higher cooling power for cooling the fuel cell device 2 is available in the second operating mode B, the power of the fuel cell device 2 can be increased so that the required drive power can be satisfied completely or almost completely by the fuel cell device 2. In other words, the power of the fuel cell device 2 is able to be varied on the basis of the operation of the cooling system in the first or second operating mode A, B.

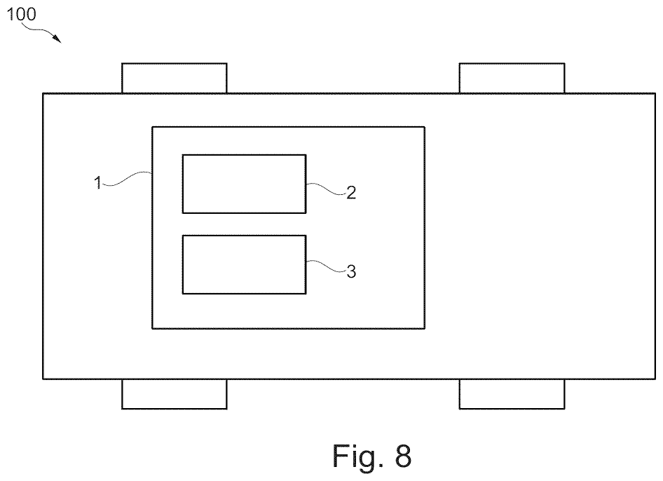

FIG. 8 shows a schematic block diagram representing a motor vehicle 100. The motor vehicle 100 is in the form of a passenger car and has a fuel cell device 2 and an electrical energy store 3 which provide the drive power of the motor vehicle 100 either individually or together. The fuel cell device 2 and the electrical energy store 3 are cooled by a cooling system 1′, 1″ which is designed according to the first or second embodiment and allows cooling in the first or second operating mode A, B.

The proposed cooling system and the associated method allow for an increase in the cooling capacity of the cooling means of the fuel cell device 2 by incorporating the cooling means of the electrical energy store 3 so that the fuel cell device 2 may be operated at a higher power without reducing the drive power of the motor vehicle due to insufficient power of the fuel cell device 2. Alternatively, for constant power of the fuel cell device 2, the cooling means thereof can be dimensioned smaller so installation space can be saved. Optimization between these two variants is also possible.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a fuel cell;
an electrical energy store electrically connected to the fuel cell;
a first cooling circuit configured to circulate a liquid coolant through the fuel cell;
a second cooling circuit configured to circulate the liquid coolant through the electrical energy store;
at least one controllable valve selectively coupling the first cooling circuit and the second cooling circuit; and
a controller in communication with the at least one controllable valve, the controller programmed to control the at least one controllable valve to fluidly isolate the first cooling circuit and the second cooling circuit when operating in a first mode and to fluidly connect the first cooling circuit and the second cooling circuit when operating in a second mode.

2. The vehicle of claim 1 wherein the controller is programmed to operate the at least one controllable valve in either the first mode or the second mode responsive to temperature of the electrical energy store and temperature of the fuel cell.

3. The vehicle of claim 2 wherein the first cooling circuit comprises a heat exchanger configured to exchange heat between the coolant of the first cooling circuit and ambient air.

4. The vehicle of claim 3 wherein the first cooling circuit comprises a coolant pump.

5. The vehicle of claim 3 further comprising:
a bypass line configured to bypass the heat exchanger;
a temperature control valve arranged at a branch-off point of the bypass line; and
a temperature sensor arranged directly upstream of the fuel cell and configured to measure temperature of the coolant;
wherein the controller is programmed to control the temperature control valve to control coolant flow through the bypass line in response to a signal from the temperature sensor.

6. The vehicle of claim 5 wherein the first cooling circuit comprises an equalizing vessel.

7. The vehicle of claim 5 wherein the second cooling circuit comprises a cooler configured to exchange heat between the coolant in the second cooling circuit and a refrigerant.

8. The vehicle of claim 7 wherein the second cooling circuit comprises a coolant pump.

9. The vehicle of claim 7 wherein the controller is programmed to operate the at least one controllable valve to fluidly couple the first cooling circuit and the second cooling circuit while bypassing the electrical energy store.

10. The vehicle of claim 7 further comprising a second temperature sensor in communication with the controller, the second temperature sensor arranged in the second cooling circuit and configured to measure temperature of the coolant flowing through the electrical energy store.

11. The vehicle of claim 7 wherein the controller is further programmed to operate in either the first mode or the second mode in further response to at least one of: a state of charge of the electrical energy store, speed of the vehicle, ambient temperature, and a required drive power of the vehicle.

12. The vehicle of claim 7 wherein the first cooling circuit comprises a coolant removal point arranged downstream of the heat exchanger and upstream of the fuel cell such that coolant passing through the heat exchanger is routed into the second cooling circuit upstream of the cooler.

13. The vehicle of claim 7 wherein the first cooling circuit comprises a coolant recirculation point arranged downstream of the heat exchanger and upstream of the fuel cell.

14. A vehicle comprising:
a fuel cell;
an electrical energy store electrically connected to the fuel cell;
a first cooling circuit configured to circulate a liquid coolant through the fuel cell;
a heat exchanger configured to exchange heat between the coolant of the first cooling circuit and ambient air;
a second cooling circuit configured to circulate the liquid coolant through the electrical energy store;
a cooler configured to exchange heat between the coolant in the second cooling circuit and a refrigerant;
at least one controllable valve selectively coupling the first cooling circuit and the second cooling circuit; and
a controller in communication with the at least one controllable valve, the controller programmed to control the at least one controllable valve to fluidly isolate the first cooling circuit and the second cooling circuit when operating in a first mode and to fluidly connect the first cooling circuit and the second cooling circuit when operating in a second mode, the controller operating the first and second cooling circuits in one of the first mode and the second mode responsive to temperature of the coolant flowing through the fuel cell and temperature of the coolant flowing through the electrical energy store.

15. The vehicle of claim 14 further comprising a coolant removal point arranged downstream of the fuel cell and upstream of the heat exchanger.

16. The vehicle of claim 15 further comprising a coolant recirculation point arranged downstream of the heat exchanger and upstream of the fuel cell.

17. The vehicle of claim 16 further comprising:
a bypass line configured to bypass the heat exchanger;
a temperature control valve arranged at a branch-off point of the bypass line; and
a temperature sensor arranged directly upstream of the fuel cell and configured to measure temperature of the coolant at an input of the fuel cell;
wherein the controller is programmed to control the temperature control valve to control coolant flow through the bypass line in response to a signal from the temperature sensor.

18. The vehicle of claim 17 wherein the controller is programmed to operate the at least one controllable valve to fluidly couple the first cooling circuit and the second cooling circuit while bypassing the electrical energy store.
